(19) United States
(12) Patent Application Publication
(10) Pub. No.: US 2006/0188041 A1
(43) Pub. Date: Aug. 24, 2006

(54) Apparatus and method for estimating transmitted signal

(75) Inventors: Woo-jong Park, Seoul (KR); Min-seop Jeong, Seoul (KR); Sung-chung Park, Daejeon (KR); Kwy-ro Lee, Daejeon (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/357,127

(22) Filed: Feb. 21, 2006

(30) Foreign Application Priority Data
Feb. 21, 2005 (KR) 2005-0014209

(51) Int. Cl. H04L 27/06

(52) U.S. Cl. 375/343

(57) ABSTRACT

A receiver having a low computation complexity so as to estimate a transmitted includes a likelihood function calculator calculating likelihoods of transmittable signals using a currently received signal, at least one previously received signal, and an estimated signal corresponding to the at least one previously received signal; and a maximum value output unit outputting a transmittable signal corresponding to a likelihood function of the likelihood functions having a maximum value. Thus, a currently received signal can be estimated using a previously received signal, a previously estimated signal, and the currently received signal. As a result, the reliability of the estimated signal can be improved. Also, the previously estimated signal can be stored to prevent the complexity of a computation from being increased.

### CROSS-REFERENCE TO RELATED APPLICATIONS

This application claims the benefit of Korean Patent Application No. 2005-14209, filed Feb. 21, 2005, in the Korean Intellectual Property Office, the disclosure of which is incorporated herein by reference.

### BACKGROUND OF THE INVENTION

1. Field of the Invention

The present invention relates to a method of estimating a transmitted signal via a receiver, and more particularly, to a method and an apparatus for estimating a transmitted signal at a low complexity and a high efficiency.

2. Description of the Related Art

Communication apparatuses constituting communication systems have particular frequencies. In other words, the communication apparatuses transmit necessary information using set frequencies to communicate with other communication apparatuses. A process of generating frequencies used by communication apparatuses to perform communications will now be described.

FIG. 1 is a block diagram illustrating components for generating a frequency necessary for performing communications via communication apparatuses according to the prior art. A local oscillator 100, a phase locked loop (PLL) 102, and an adder 104 are shown in FIG. 1.

The local oscillator 100 generates a local oscillator signal f_{LO} having a particular frequency. The local oscillator signal f_{LO} is transmitted to the PLL 102. The PLL 102 performs an operation to stabilize the local oscillator signal f_{LO} generated by the local oscillator 100. The local oscillator signal f_{LO} stabilized by the PLL 102 is transmitted to the adder 104.

The adder 104 adds a signal f_{IF} having an intermediate frequency (IF) to the local oscillator signal f_{LO} and outputs the addition result. In other words, a frequency of a signal generated by the local oscillator 100 is low. Thus, the adder 104 adds the IF of the signal f_{IF} to the particular frequency of the local oscillator signal f_{LO} and outputs the addition result. Each communication apparatus performs the above-described process to generate a signal having a frequency with an intensity necessary for performing communications. A transmitter of a communication apparatus transmits a generated signal together with information, and a receiver receives the signal from the transmitter to obtain necessary information. The receiver obtains the necessary information from the received signal using a signal having the same frequency as that used by the transmitter.

For communications between the transmitter and the receiver, the frequency used by the transmitter must be the same as the frequency used by the receiver. If the frequency of the signal used by the transmitter is the same as the frequency of the signal used by the receiver, the receiver can accurately obtain the signal transmitted from the transmitter. However, if the frequency of the signal used by the transmitter is different from the frequency of the signal used by the receiver, the receiver fails to obtain the signal transmitted from the transmitter.

In general, frequencies of signals generated by communication apparatuses are different due to particular properties of the communication apparatuses. Also, although the frequencies of the signals generated by the communication apparatuses are the same, a frequency of a signal used by a transmitter may vary due to the characteristics of a wireless channel. Thus, although the frequency of the received signal is different from the frequency of the signal used by the receiver, the receiver requires a method of estimating the signal transmitted from the transmitter without an error.

For this purpose, the receiver estimates a signal to be transmitted from the transmitter using a currently received signal and signals that may be transmitted from the transmitter.

FIG. 2 is a block diagram illustrating a transmitted signal estimator of a receiver estimating a signal to be transmitted from a transmitter according to the prior art. A method of estimating a signal transmitted from a transmitter using a receiver according to the prior art will now be described in detail with reference to FIG. 2.

The transmitted signal estimator shown in FIG. 2 includes likelihood function calculator 200 and a maximum value output unit 202. The transmitted signal estimator may include other components besides the likelihood function calculator 200 and the maximum value output unit 202. The likelihood function calculator 200 receives a currently received signal yₙ.

The likelihood function calculator 200 calculates a likelihood function of the currently received signal yₙ. In other words, the receiver knows about a transmission form of information that may be transmitted from the transmitter. For example, if the transmitter transmits information using two bits, transmittable bit values are “00,” “01,” “10,” or “11.” Thus, the likelihood function calculator 200 calculates the likelihood function of the currently received signal yₙ. In other words, the likelihood function calculator 200 calculates a correlation between received and transmittable signals to calculate a likelihood function that is a probability that the currently received signal yₙ will be a signal from which the correlation has been calculated.

As shown in FIG. 2, the likelihood function calculator 200 transmits likelihood functions of M transmittable signals to the maximum value output unit 202. Signals that may be transmitted from the transmitter are s⁽⁰⁾ through s^{(M-1)}, the likelihood functions of the transmittable signals output from the likelihood function calculator 200 are L(s⁽⁰⁾) through L(s^{(M-1)}). The likelihood function of the transmittable signal s⁽⁰⁾ is L(s⁽⁰⁾), and the likelihood function of the transmittable signal s^{(M-1)} is L(s^{(M-1)}).

The maximum value output unit 202 estimates a transmittable signal corresponding to a likelihood function of the received likelihood functions having a maximum value as a received signal and outputs the received signal. Referring to FIG. 2, an estimated signal output from the maximum value output unit 202 is Ŝₙ.

However, in the above-described method, in a case where a frequency offset is within an allowable range, a probability that an error will occur in an estimated signal is reduced. If the frequency offset exceeds the allowable range, the probability that the error will occur in the estimated signal is increased. The probability that the error will occur in the estimated signal varies depending on a reception time.

FIG. 3 is a view illustrating a signal transmitted from a transmitter and the signal received from the transmitter to a receiver. As shown in FIG. 3, a frequency used by the transmitter is different from a frequency used by the receiver. Thus, the signal transmitted from the transmitter is also different from the signal received by the receiver.

The reason why an error occurring in an estimated signal varies with a reception time will now be described with reference to FIG. 3. A signal transmitted at a time A is received by the receiver at a time A′, and a signal transmitted at a time B is received by the receiver at a time B′. A signal transmitted at a time C is received by the receiver at a time C, and a signal transmitted at a time D is received by the receiver at a time D′.

However, as the reception time advances from A′ to D′, a difference between transmitted and received signals is also increased. In other words, there is a greater difference between the transmitted and received signals at the time D′ than between the transmitted and received signals at the time A′. Thus, a method of accurately estimating a transmitted signal via the receiver is required.

### SUMMARY OF THE INVENTION

Accordingly, an aspect of the present general inventive concept is to provide a method of accurately estimating a transmitted signal using a receiver.

Another aspect of the present general inventive concept is to provide a reception structure of a receiver having low computation complexity and high performance so as to estimate a transmitted signal.

According to an aspect of an exemplary embodiment of the present invention, there is provided a method of estimating a transmitted signal using a received signal via a receiver in a communication system including a transmitter and the receiver receiving the received signal from the transmitter, including: calculating likelihood functions of transmittable signals using a currently received signal, at least one previously received signal, and an estimated signal corresponding to the at least one previously received signal; and estimating a transmittable signal corresponding to a likelihood function of the likelihood functions having a maximum value as the transmittable signal.

According to another aspect of an exemplary embodiment of the present invention, there is provided an apparatus for estimating a transmitted signal using a received signal in a communication system including a transmitter and a receiver receiving the received signal from the transmitter, including: a likelihood function calculator calculating likelihood functions of transmittable signals using a currently received signal, at least one previously received signal, and an estimated signal corresponding to the at least one previously received signal; and a maximum value output unit outputting a transmittable signal corresponding to a likelihood function of the likelihood functions having a maximum value.

### BRIEF DESCRIPTION OF THE DRAWINGS

The above aspects and features of the present invention will be more apparent by describing certain embodiments of the present invention with reference to the accompanying drawings, in which:

FIG. 1 is a block diagram illustrating components for generating frequencies used for communications;

FIG. 2 is a block diagram illustrating components of a receiver for estimating a transmitted signal according to the prior art;

FIG. 3 is a view illustrating problems occurring due to a difference between frequencies used by a transmitter and a receiver according to the prior art;

FIG. 4 is a view illustrating samples set to estimate a transmitted signal from a received signal;

FIG. 5 is a block diagram of a structure of a double correlation calculator according to an exemplary embodiment of the present invention;

FIG. 6 is a view illustrating signals used to estimate a current signal according to an exemplary embodiment of the present invention;

FIG. 7 is a block diagram of components of a receiver for estimating a transmitted signal according to an exemplary embodiment of the present invention; and

FIG. 8 is a block diagram illustrating a structure of a likelihood function calculator according to an exemplary embodiment of the present invention.

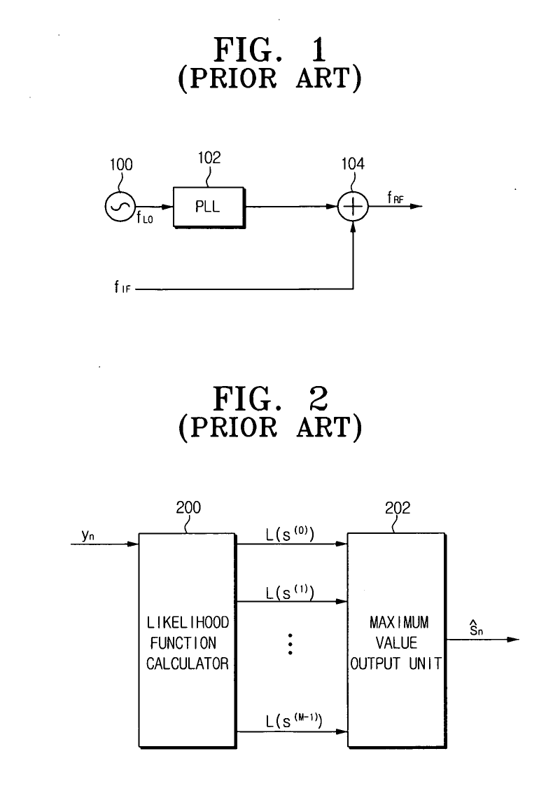

### DETAILED DESCRIPTION OF THE EXEMPLARY EMBODIMENTS

Certain embodiments of the present invention will be described in greater detail with reference to the accompanying drawings.

In the following description, same drawing reference numerals are used for the same elements even in different drawings. The matters defined in the description such as a detailed construction and elements are provided to assist in a comprehensive understanding of the invention. Thus, it is apparent that the present invention can be carried out without those defined matters. Also, well-known functions or constructions are not described in detail.

A receiver of the present invention uses double correlations between received signals and transmittable signals to estimate a transmitted signal. A double correlation will now be described. The double correlation can be calculated using Equation 1:

$${C}_{n , d} ( {s}^{( m )} ) = {\sum }_{k = d}^{K - 1} {y}_{n , k}^{*} {y}_{n , k - d} {s}_{k} {s}_{k - d}^{*} \qquad ( 1 )$$

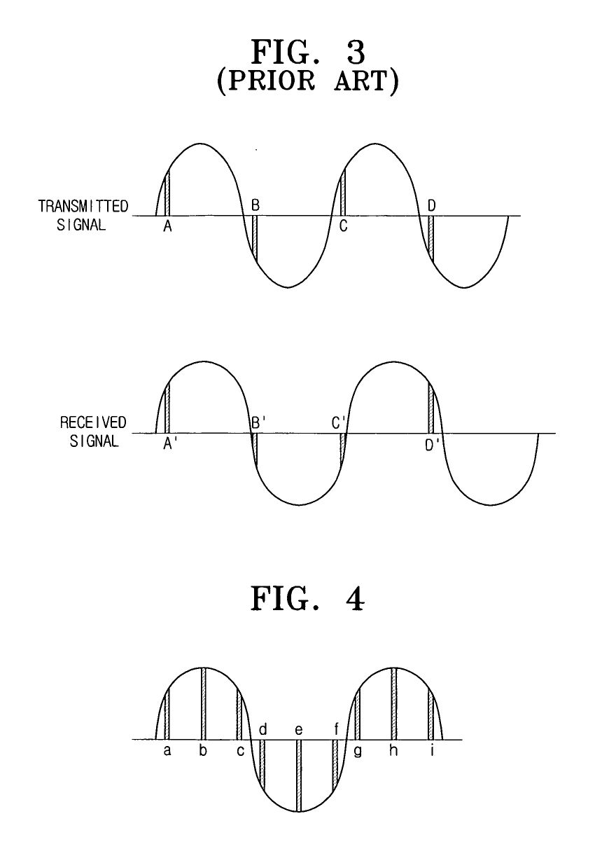

A method of calculating a double correlation will now be described in detail with reference to Equation 1 and FIG. 4. FIG. 4 is a view illustrating a received signal. A number of samples from which double correlations are to be obtained is set from the received signal. As shown in FIG. 4, a number of samples from which double correlations are to be obtained is set to “9,” and the set samples are a through i. In Equation 1, K denotes the number of samples from which the double correlations are to be obtained, y*_{n,k} denotes a correlation function of y_{n,k,} and s*_{k-d} denotes a correlation function of s_{k-d}.

On the assumption that a double correlation calculator calculates a double correlation, samples used by the double correlation calculator to calculate the double correlation will be described.

The double correlation calculator measures a double correlation between samples between which one interval exists and then a double correlation between samples among which two intervals exist. The double correlation calculator measures a double correlation among samples among which three intervals exist. As a result, the double correlation calculator can measure a double correlation in a signal. Table 1 below shows samples used by the double correlation calculator to calculate the double correlation of the signal shown in FIG. 4.

TABLE 1

| Intervals between | |
|---|---|
| Measured Samples | Used Samples |
| 1 | (a and b), (b and c), (c and d), (d and e), (e and f), |
| | (f and g), (g and h), (h and i) |
| 2 | (a and c), (b and d), (c and e), (d and f), (e and g), |
| | (f and h), (g and i) |
| 3 | (a and d), (b and e), (c and f), (d and g), (e and h), |
| | (f and i) |
| 4 | (a and e), (b and f), (c and g), (d and h), (e and i) |
| 5 | (a and f), (b and g), (c and h), (d and i) |
| 6 | (a and g), (b and h), (c and i) |
| 7 | (a and h), (b and i) |
| 8 | (a and i) |

As shown in Table 1, the double correlation calculator measures double correlations of samples among which intervals is “1” through “8.” However, the double correlation calculator may measure double correlations of the samples among which intervals are at least one of “1” through “8.”

FIG. 5 is a block diagram illustrating a structure of a double correlation calculator according to an embodiment of the present invention. The structure of the double correlation calculator according to an embodiment of the present invention will now be described in detail with reference to FIG. 5.

A correlation unit 500 calculates a correlation function y*_{n,k} of a received signal y_{n,k} and transmits the correlation function y*_{n,k} to a multiplier 502. The multiplier 502 multiplies the correlation function y*_{n,k} by a transmittable signal Sₖ to output a multiplied signal y*_{n,k}Sₖ. The multiplied signal y*_{n,k}Sₖ output from the multiplier 502 is transmitted to a delayer 504 and a multiplier 508.

The delayer 504 delays the multiplied signal y*_{n,k}Sₖ by a number of set samples to output a delayed signal y*_{n,k-d} S_{k-d}. As shown in FIG. 5, a time required for delaying the multiplied signal y*_{n,k}Sₖ via the delayer 504 is d. In other words, the delayer 504 outputs a signal corresponding to a sample delayed by a time d corresponding to a sample interval.

The delayed signal y*_{n,k-d} S_{k-d} output from the delayer 504 is transmitted to a correlation unit 506.

The correlation unit 506 calculates a correlation function y_{n,k-d}S*_{k-d} of the delayed signal y*_{n,k-d} S_{k-d} and transmits the correlation function y_{n,k-d}S_{k-d} to the multiplier 508. The multiplier 508 multiplies the signal y*_{n,k}Sₖ received from the multiplier 502 by the correlation function y_{n,k-d}S*_{k-d} to output a multiplied signal y*_{n,k}Sₖy_{n,k-d}S*_{k-d}. The multiplied signal y*_{n,k}Sₖy_{n,k-d}S*_{k-d} output from the multiplier 508 is transmitted to an operator 510. The operator 510 performs an operation as in Equation 1 on the multiplied signal y*_{n,k}Sₖy_{n,k-d}S*_{k-d}. In other words, the operator 510 measures a double correlation between samples between which one interval exists and a double correlation among samples among which 8 intervals exist.

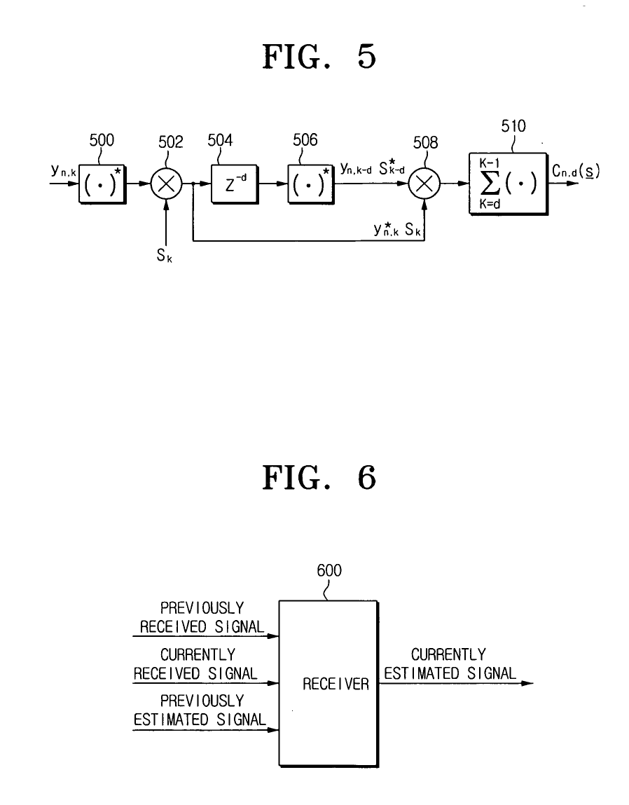

FIG. 6 is a view illustrating signals used by a receiver 600 to estimate a transmitted signal according to an embodiment of the present invention. Referring to FIG. 6, the receiver 600 receives a previously received signal), a currently received signal, and a previously estimated signal. The receiver 600 outputs a currently estimated signal using the previously received signal, the currently received signal, and the previously estimated signal.

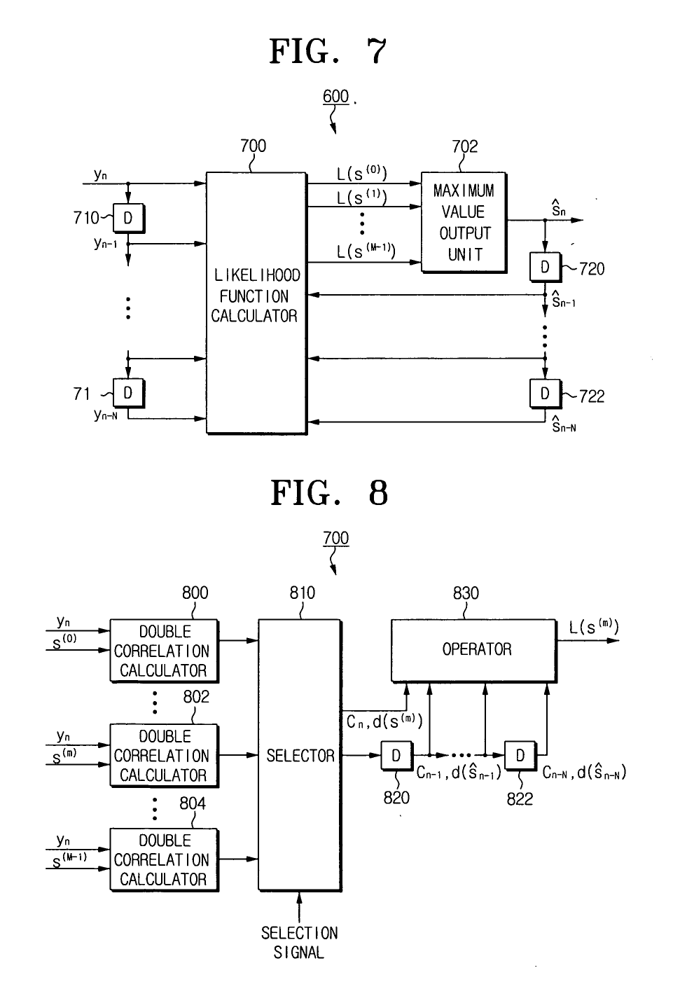

FIG. 7 is a block diagram illustrating a structure of a receiver 600 compensating for a frequency offset according to an embodiment of the present invention. Referring to FIG. 7, the receiver 600 includes a plurality of delayers 710 through 712 delaying received signals, a likelihood function calculator 700, a maximum value output unit 702, and a plurality of delayers 720 through 722 delaying estimated signals. The receiver 600 may include other components besides the above-mentioned components. However, for convenience, only necessary components are shown in FIG. 7.

The likelihood function calculator 700 receives a currently received signal. The likelihood function calculator 700 also receives a plurality of previously received signals delayed by the plurality of delayers 710 through 712. In other words, if the currently received signals is yₙ, the previously received signal delayed by the delayer 710 is Yₙ₋₁, and the previously received signal delayed by the delayer 712 is y_{n-N}. The likelihood function calculator 700 also receives previously estimated signals from the maximum value output unit 702. In other words, if the currently estimated signal is Ŝₙ, the previously estimated signal delayed by the delayer 720 is Ŝ_{n-31 1}, and the previously received signal delayed by the delayer 722 is Ŝ_{n-N}. Thus, referring to FIG. 7, a number of signals transmitted to the likelihood function calculator 700 is “2N+1”. As described above, a number of delayers may vary by setting of a user.

The likelihood function calculator 700 calculates likelihood functions of a plurality of received signals. The operation of the likelihood function calculator 700 can be expressed as in Equation 2:

$$L ( {s}^{( m )} ) = {\sum }_{d = 1}^{K - 1} {\vert {C}_{n , d} ( {s}^{( m )} ) + {\sum }_{{n}^{′} = 1}^{N} {C}_{n - {n}^{′} , d} ( {\hat{s}}_{n - {n}^{′}} ) \vert}^{2} \qquad ( 2 )$$

wherein C_{n,d}(s^{(m)}) is as shown in Equation 1. Referring to Equation 2, a currently received signal, a previously received signal, and a previously estimated signal are used to estimate the currently received signal.

As shown in FIG. 7, the likelihood calculator 700 calculates likelihood functions of M transmittable signals using a currently received signal yₙ, N previously received signals y_{n-n′} (n′=1, . . . , and N) and previously estimated signals Ŝ_{n-n′} (n′=1, . . . , and N) to estimate an n^{th} signal received from a transmitter. Referring to FIG. 7, signals that may be transmitted from the transmitter are s⁽⁰⁾ through s^{(M-1)}, the likelihood functions output from the likelihood function calculator 700 are L(s⁽⁰⁾) through L(s^{(M-1)}). In other words, the likelihood function of the transmittable signal s⁽⁰⁾ is L(s⁽⁰⁾), and the likelihood function of the transmittable signal s^{(M-1)} is L(s^{(M-1)}).

The maximum value output unit 702 selects and outputs an estimated signal corresponding to a likelihood function of received likelihood functions having a maximum value. Referring to FIG. 7, the estimated signal output from the maximum value output unit 702 is Ŝₙ.

Equation 2, i.e., operation of the likelihood calculator, will now be described in detail with reference to FIG. 8. FIG. 8 is a block diagram illustrating a structure of a likelihood function calculator 700 according to an embodiment of the present invention.

Referring to FIG. 8, the likelihood calculator 700 includes a plurality of double correlation calculators 800, . . . , 802, . . . , and 804, a selector 810, a plurality of delayers 820, . . . , and 822, and an operator 830.

The double correlation calculators 800, . . . , 802, . . . , and 804 calculate double correlations between currently received signals and signals that may be transmitted from a transmission node. In other words, the double correlation calculator 800 calculates and outputs a double correlation C_{n,d}(s⁽⁰⁾) between a currently received signal and a transmittable signal s⁽⁰⁾. The double correlation calculator 802 calculates and outputs a double correlation C_{n,d(s}^{(m-1)}) between a currently received signal and a transmittable signal s^{(m-1)}. The double correlation calculator 804 calculates and outputs a double correlation C_{n,d}(s^{(M-1)}) between a currently received signal and a transmittable signal s^{(M-1)}.

For convenience, a process of calculating a likelihood function of a transmittable signal s^{(m)} will now be described. The selector 810 transmits the double correlation C_{n,d}(s^{(m-1)}) of a plurality of double correlations between the transmittable signal s^{(m)} and the currently received signal to the operator 830. The operator 830 receives a double correlation C_{n-1,d}(Ŝₙ₋₁) between a previously estimated signal Ŝₙ₋₁ received from the delayer 820 and a previously received signal yₙ₋₁ from the delayer 820. The operator 830 receives a double correlation C_{n-N,d}(Ŝ_{n-N}) between a previously estimated signal Ŝ_{n-N} received from the delayer 822 and a previously received signal y_{n-N}. In other words, the operator 830 receives the double correlations C_{n,d}(s^{(m-1)}), C_{n-1,d}(Ŝₙ₋₁), and C_{n-N,d}(Ŝ_{n-N}).

The operator 830 performs the operation shown in Equation 1 using received double correlations. In other words, the operator 830 calculates the likelihood function L(s^{(m)} of the transmittable signal s^{(m)}.

As described above, in the present invention, a double correlation of a previously received signal can be calculated using a previously estimated signal so as to prevent the complexity of the calculation from being increased. In exemplary embodiments of the present invention, a previously estimated signal can be stored so as to calculate a double correlation from the stored estimated signal and a previously received signal.

As described above, in a method and an apparatus for estimating a transmitted signal according to exemplary embodiments of the present invention, a currently received signal can be estimated using the currently received signal, previously received signals, and previously estimated signals. Thus, the performance of a receiver can be improved. Also, the previously estimated signals can be stored to estimate a current signal using the stored signals. Thus, computation complexity is not increased. As a result, a transmitter and a receiver can be realized at a low cost.

The foregoing embodiment and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A method of estimating a transmitted signal using a received signal, comprising:
calculating likelihood functions of transmittable signals using a currently received signal, at least one previously received signal, and an estimated signal corresponding to the at least one previously received signal; and
estimating a transmittable signal corresponding to a likelihood function of the likelihood functions having a maximum value as the transmittable signal.

2. The method of claim 1, wherein the at least one previously received signal and the estimated signal corresponding to the at least one previously received signal are stored for a predetermined period of time.

3. The method of claim 1, wherein the likelihood function is calculated using Equation below:
$$L ( {s}^{( m )} ) = {\sum }_{d = 1}^{K - 1} {\vert {C}_{n , d} ( {s}^{( m )} ) + {\sum }_{{n}^{'} = 1}^{N} {C}_{n - {n}^{′} , d} ( {\hat{s}}_{n - {n}^{′}} ) \vert}^{2}$$
where L(s^{(m)}) denotes a likelihood function of a transmittable signal s^{(m)}, C_{n,d}(s^{(m)}) denotes a double correlation between a currently received signal yₙ and the transmittable signal s^{(m)}, C_{n-n′,d}Ŝ_{n-n′} denotes a double correlation between a previously received signal y_{n-n′} and an estimated signal Ŝ_{n-n′} corresponding to the previously received signal y_{n-n′}, and K denotes a number of samples set to measure a double correlation from a received signal.

4. An apparatus for estimating a transmitted signal using a received signal, comprising:
a likelihood function calculator configured to calculate likelihood functions of transmittable signals using a currently received signal, at least one previously received signal, and an estimated signal corresponding to the at least one previously received signal; and
a maximum value output unit configured to output a transmittable signal corresponding to a likelihood function of the likelihood functions having a maximum value.

5. The apparatus of claim 4, further comprising:
a delayer configured to delay a received signal for a predetermined period of time and transmit the delayed signal to the likelihood function calculator.

6. The apparatus of claim 5, further comprising:
a delayer configured to delay the estimated signal for a predetermined period of time and transmit the delayed signal to the likelihood function calculator.

7. The apparatus of claim 4, wherein the likelihood function calculator calculates a likelihood function using Equation below:
$$L ( {s}^{( m )} ) = {\sum }_{d = 1}^{K - 1} {\vert {C}_{n , d} ( {s}^{( m )} ) + {\sum }_{{n}^{′} = 1}^{N} {C}_{n - {n}^{′} , d} ( {\hat{s}}_{n - {n}^{′}} ) \vert}^{2}$$
where L(s^{(m)}) denotes a likelihood function of a transmittable signal s^{(m)}, C_{n,d}(s^{(m)}) denotes a double correlation between a currently received signal yₙ and the transmittable signal s^{(m)}, C_{n-n′,d}Ŝ_{n-n′} denotes a double correlation between a previously received signal y_{n-n′} and an estimated signal Ŝ_{n-n′} corresponding to the previously received signal y_{n-n′}, K denotes a number of samples set from a received signal to measure a double correlation.

8. The apparatus of claim 7, wherein the likelihood function calculator comprises:
a double correlation calculator configured to extract a plurality of samples from the received signal and calculate a double correlation between two of the extracted samples and a transmittable signal selected from the samples.

9. The apparatus of claim 8, wherein the double correlation calculator extracts samples among which one interval exists, from the plurality of samples.

10. The apparatus of claim 8, wherein if the number of the set samples is K, the double correlation calculator extracts samples among which one interval exists and samples among which K-1 intervals exist.

11. The apparatus of claim 7, wherein the likelihood function calculator further comprises double correlation calculators, wherein a number of double correlation calculators is identical to a number of the transmittable signals.

12. The apparatus of claim 1 1, wherein the likelihood function calculator further comprises a selector configured to output a double correlation selected from a plurality of double correlations according to a selection signal.

13. The apparatus of claim 1 1, wherein the likelihood function calculator further comprises an operator configured to calculate a likelihood function using the double correlation received from the selector and a double correlation between at least one previously received signal and an estimated signal corresponding to the at least one previously received signal.
